(19) United States
(12) Patent Application Publication
(10) Pub. No.: US 2026/0226888 A1
(43) Pub. Date: Aug. 6, 2026

(54) Improved axial piston hydraulic machine

(71) Applicant: STEM Numerical Engineering Srl, Modena (IT)

(72) Inventor: Mario Antonio Morselli, Modena (IT)

(21) Appl. No.: 19/150,875

(22) PCT Filed: Jan. 23, 2024
(86) PCT No.: PCT/IB2024/050639

§ 371 Date: Jul. 24, 2025

(30) Foreign Application Priority Data
Jan. 25, 2023 (IT) 102023000001134

(51) Int. Cl. F04B 1/124; F03C 1/32; F04B 1/2078; F04B 17/00

(52) U.S. Cl. CPC F04B 1/124; F03C 1/0626; F04B 1/2078; F04B 17/00

(57) ABSTRACT

A hydraulic machine includes a cylinder block with a body having a plurality of pistons in respective axial seats, each piston having a first end within the axial seat and an opposite second end. An inclined plate contacts the second ends of the pistons, a relative rotation between the body and the inclined plate generating an axial movement of each piston that is related to a fluid contained in the respective axial seat. Each piston has, at the second end, a contact sphere and a seat therefor, the contact sphere being rotatable within the seat and protruding from an opening of the seat to contact the inclined plate. The seat of the contact sphere is in fluid communication with the axial seat of a respective piston such that the fluid at least partially fills the volume between the contact sphere and the inner side surface of the seat.

The present invention refers to an improved axial piston hydraulic machine. In particular, the present invention refers to an improved hydraulic machine consisting of an inclined plate axial piston motor (swash-plate).

In the following, reference will be made to a hydraulic machine consisting of an axial piston pump.

As is known, axial piston pumps generally comprise a cylinder block comprising a rotatable cylindrical body and inside which pumping pistons with axes parallel to each other and distributed along a cylindrical surface with a circular section are housed. With particular reference to the inclined plate axial piston pumps (swash-plate), in which the cylindrical body housing the pumping pistons is coaxial with the drive shaft, at the end of the stem of each of said pumping pistons there is a skid adapted to slide on a plate inclined relative to the longitudinal rotation axis of the cylindrical body. The skids are pressed into contact with the inclined plate by means of a holding device, which is known by the term “retainer” and which is pressed to rest against the upper edge of the skid by a generally spring-loaded pressing device. The rotation of the group of pumping pistons with respect to the inclined plate causes an axial movement of the pumping pistons which, depending on the movement direction, respectively results in a suction or delivery of liquid. It is also possible that the inclined plate rotates around its own central rotation axis, while the cylindrical body housing the pumping pistons is fixed. In any case, the inclined plate operates substantially as a cam that converts a rotational movement into an alternating axial movement of the pumping pistons within the respective cylinders.

An axial piston pump also has a distribution plate which is arranged at the end of the cylindrical body opposite to the one turned towards the inclined plate and which comprises a suction port and a delivery port, which are always in liquid communication with a certain number of pumping pistons. In this way, during operation of the pump, a certain number of pumping pistons sucks liquid from the suction port while a certain number of pumping pistons sends liquid through the delivery port. The axial piston pumps of this type can be fixed displacement pumps, when the inclination of the plate with respect to the pumping pistons is fixed, or variable displacement pumps, when it is possible to vary the inclination of the plate with respect to the pumping pistons so as to vary the excursion of the same.

To date, it is known that one of the most critical components of the axial piston pumps most susceptible to malfunctions and wear is the sliding skid on the inclined plate.

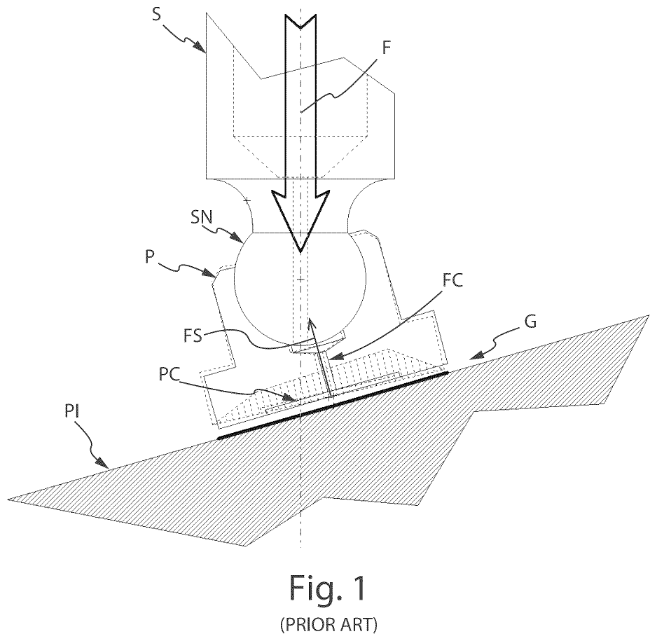

FIG. 1 illustrates the end S of a pumping piston to which a skid P, also known in the sector by the term “slipper” is associated by means of a sphere joint SN. The space G (“gap”) between the lower surface of the skid P and the inclined plate PI is in fluid communication with the cylinder in which the pumping piston slides by means of a central sump PC and calibrated holes obtained in the skid P and in the pumping piston itself.

As illustrated in FIG. 1, both by effect of the centrifugal force acting on the skid P during its sliding on the inclined plate PI, and due to the viscous friction and contact forces that are generated between the skid P and the inclined plate PI, despite the hydrostatic pressure generated by the film of liquid present in the space G (“gap”) between the skid P and the plate PI, the skid P does not remain parallel to the inclined plate PI and tends to come into contact with it, generating unwanted friction forces and causing wears of the surfaces of the skid P and plate PI in mutual contact.

This phenomenon is at least partly due to the impossibility of guaranteeing and maintaining the desired parallelism between the inclined plate PI and the skid P both for structural reasons of assembly, such as coupling tolerances among the various components, and for reasons of production tolerances of the components themselves, where these tolerances are often of the same order of magnitude as the dimensions of the liquid meatus that is formed between the skid and the inclined plate, i.e. the distance between the skid and the inclined plate. In addition, the contamination particulate present in the liquid also has dimensions that are sometimes comparable to those of the liquid meatus and contributes to generating phenomena of wear and of wedging of the skid with respect to the inclined plate.

As mentioned above, in the known pumps there is also a “retainer” that presses the skids against the inclined plate.

The “retainer” is pressed against the upper edge of each skid. However, since there are a plurality of pistons (generally nine) each provided with a respective skid, it is evident that the thickness of the upper edge of each skid is not and cannot be strictly constant nor along it (which generates a parallelism error between said upper edge on which the “retainer” presses and the lower plane of the respective skid resting on the inclined plate), nor between different skids. Similarly, the planarity of both the inclined plate and of the “retainer” is not and cannot be perfect. Therefore, even if these geometric errors of parallelism and/or planarity are individually equal to even a few thousandths of a millimetre, their sum reaches values in the order of 10-15 microns. If we consider that, generally, the “gap” G between the lower plane of each skid and the upper surface of the inclined plate is in the order of 5-20 microns, it is evident that the action of the “retainer” has an insurmountable intrinsic limit in its effectiveness in maintaining the parallelism between the lower plane of each skid and the upper surface of the inclined plate.

In these known pumps, moreover, the space G (“gap”) between skids P and inclined plate PI is one of the major causes of volumetric loss, since a space high enough to limit the unwanted contacts between them as described above is to be maintained.

Another critical aspect of these known pumps is related to the side force that is generated between the skids and the inclined plate and that is discharged on the cylinder block generating wear and friction in the contact between pistons and liners of the respective cylinders.

The main task of the present invention consists in realizing an improved axial piston hydraulic machine, in particular an inclined plate axial piston pump or motor, which solves the technical problem set forth above, preventing malfunctions and unwanted wears.

Within the scope of this task, an object of the present invention is to realize an improved axial piston hydraulic machine that is able to operate efficiently even during the start and stop transients, as well as under conditions of low load and/or at low rotation speeds as well as at high rotation speeds.

Another object of the invention consists in realizing an improved axial piston hydraulic machine in which it is possible to avoid the occurrence of edge contacts between skids and inclined plate, that is, between the planes of the skids and the plane of the inclined plate which slide on each other.

A further object of the invention consists in realizing an improved axial piston hydraulic machine whose operation is affected to a lesser and negligible extent by the presence of impurities in the liquid to be pumped, for example contamination particles in the oil.

Yet another object of the invention consists in realizing an improved axial piston hydraulic machine, in particular an inclined plate axial piston pump or motor, which is able to guarantee a better efficiency, both volumetric and mechanical, compared to the prior art.

Yet another object of the invention consists in realizing an improved axial piston hydraulic machine, in particular an inclined plate axial piston pump or motor, which is able to guarantee that the axial force generated in the interaction between skids and inclined plate is on average of lesser extent than in the prior art and with gradual course during their relative rotation.

Yet another object of the invention consists in realizing an improved axial piston hydraulic machine that is able to give the widest guarantees of reliability and safety in use and that is also easy to be realized and economically competitive when compared to the prior art.

The task set forth above, as well as the purposes mentioned and others that will become clearer later, are achieved by an axial piston hydraulic machine as set forth in claim 1.

Other features are provided in the dependent claims.

Further characteristics and advantages will become more apparent from the description of preferred, but non-exclusive, embodiments of an improved axial piston hydraulic machine, illustrated by way of indicative and non-limiting example with the aid of the accompanying drawings in which:

FIG. 1 schematically illustrates a skid of known type of an axial piston pump of known type;

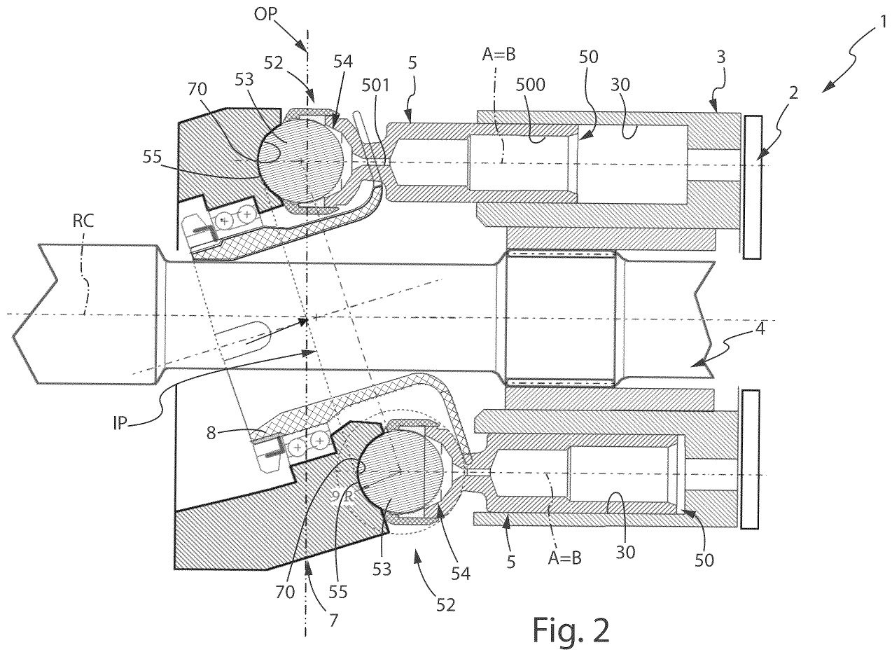

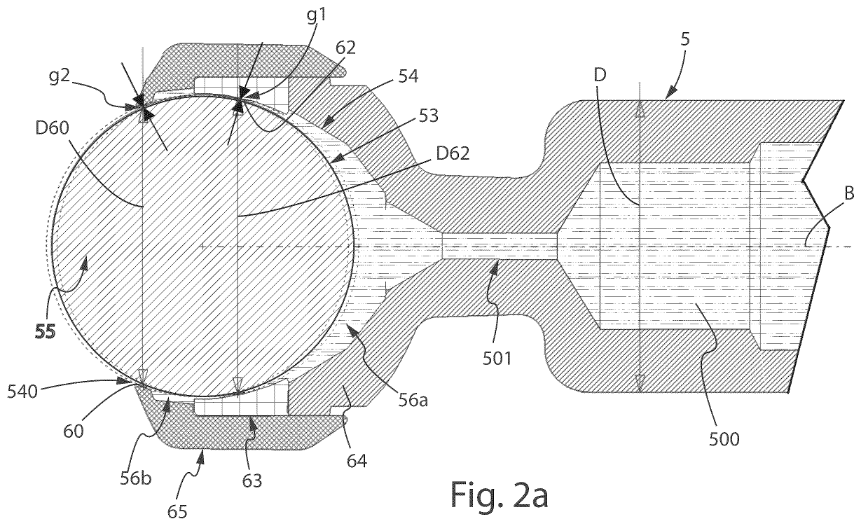

FIG. 2 is a longitudinal sectional view of part of an embodiment of a hydraulic machine of the type of an improved axial piston pump, according to the invention;

FIG. 2a is an enlarged view of a detail of FIG. 2;

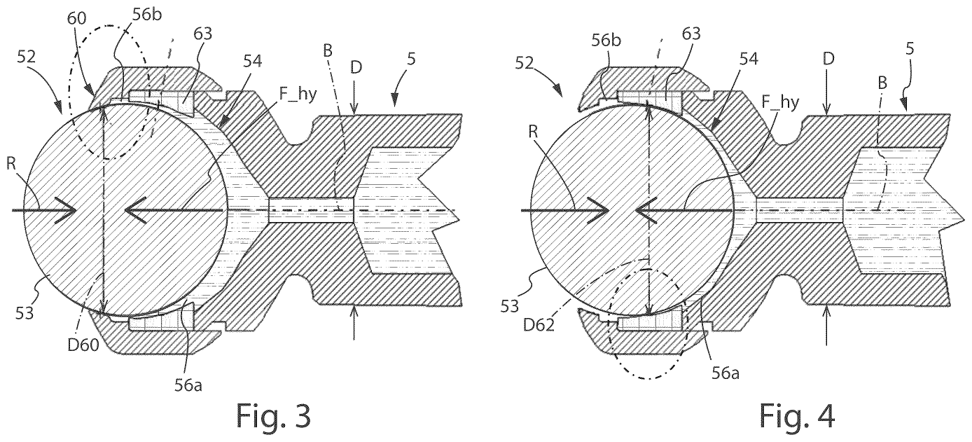

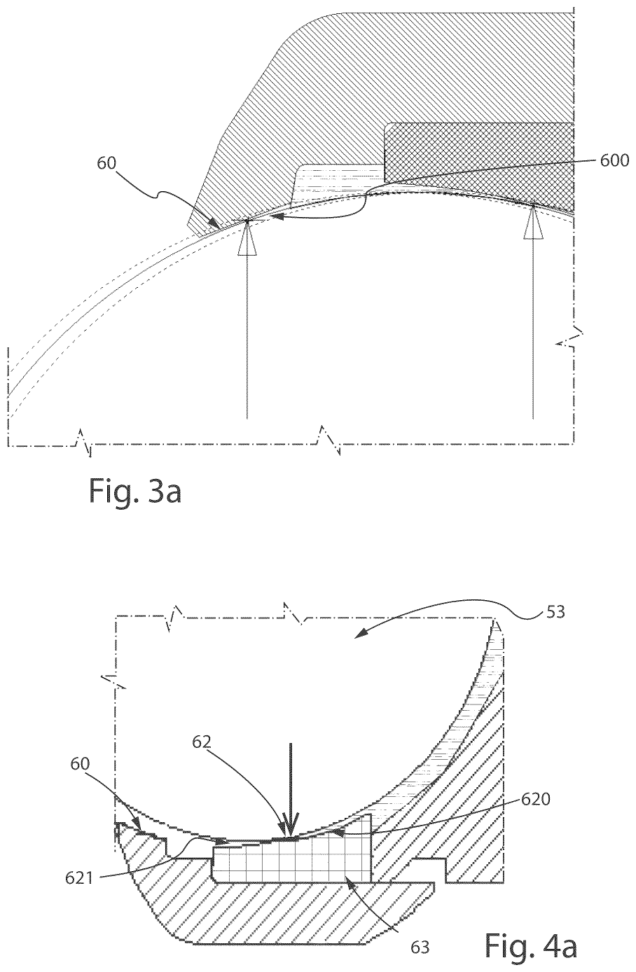

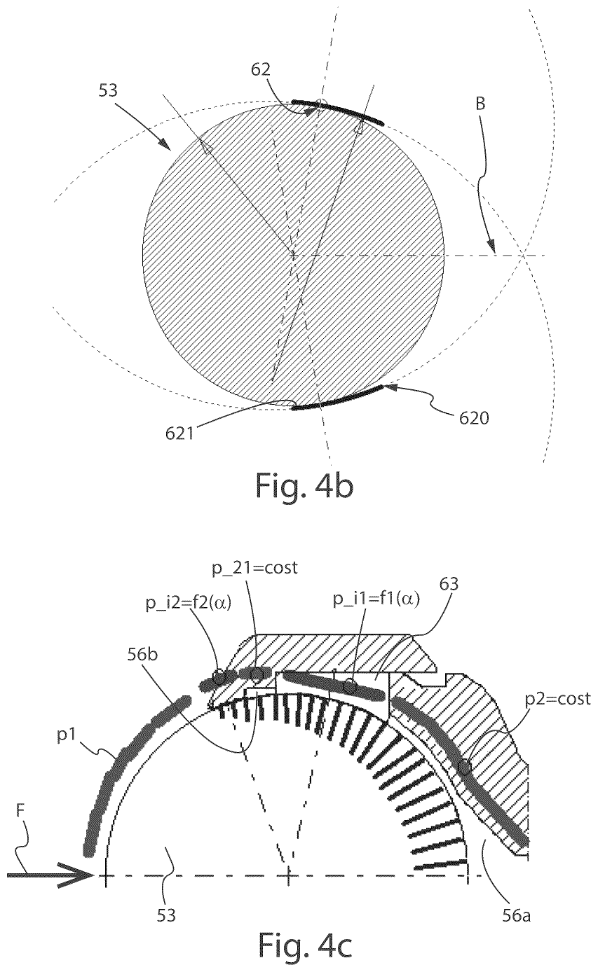

FIGS. 3 and 4 schematically illustrate, in a longitudinal sectional view, the end of a pumping piston of the pump of FIG. 2, in two different operating conditions;

FIGS. 3a and 4a show on an enlarged scale the details highlighted in FIG. 3 and FIG. 4, respectively;

FIG. 4b schematically shows the obtainment of the surfaces that define the inner side surface of the sphere housing seat at the areas referred to in the details illustrated in FIGS. 3a and 4a;

FIG. 4c illustrates a detail of FIG. 4 with notes relating to the trend of the pressure of the pumped fluid;

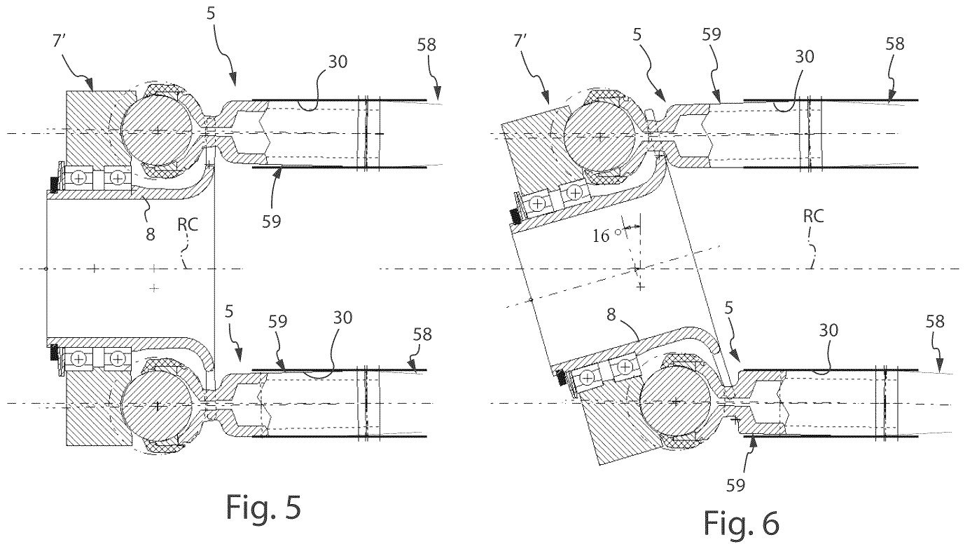

FIGS. 5 and 6 schematically illustrate, in longitudinal sectional view, a variant of the hydraulic machine of the type of an axial piston pump according to the invention, with variable displacement;

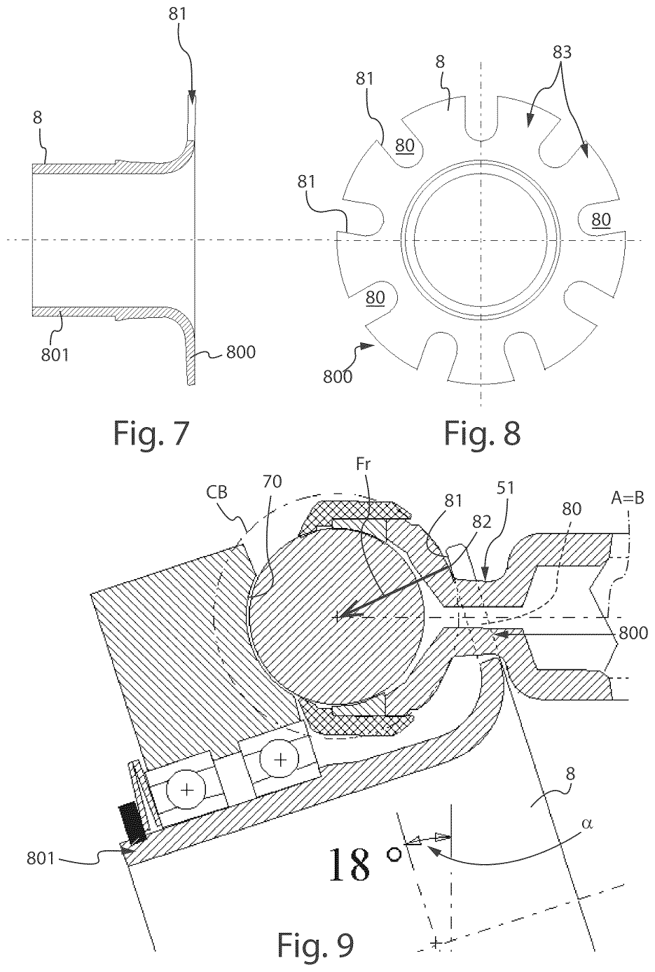

FIGS. 7 and 8 illustrate a component of the axial piston pump, respectively in a longitudinal sectional view and in a front view;

FIG. 9 illustrates an enlarged portion, in detail, of the axial piston pump of FIG. 2;

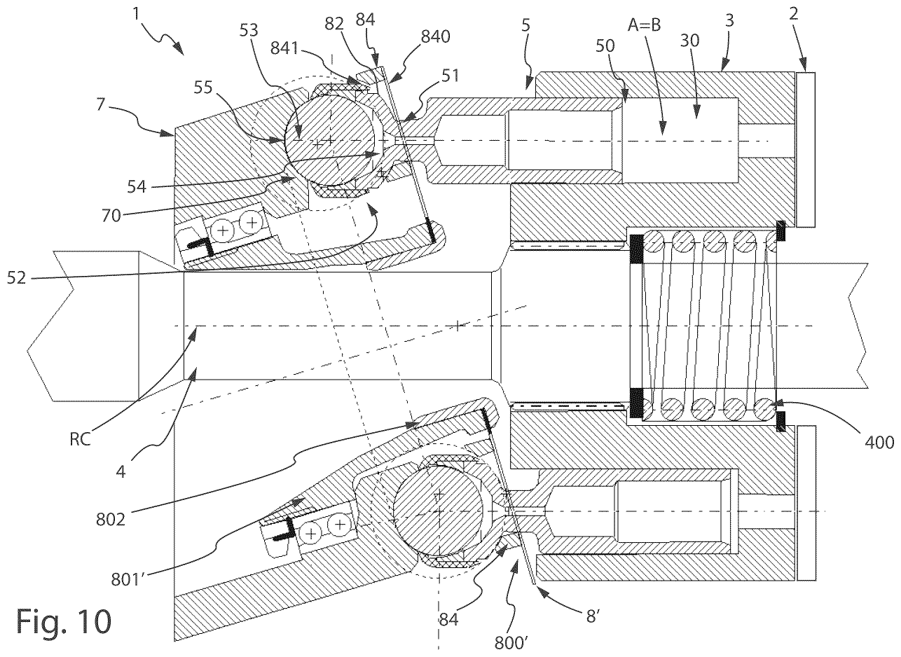

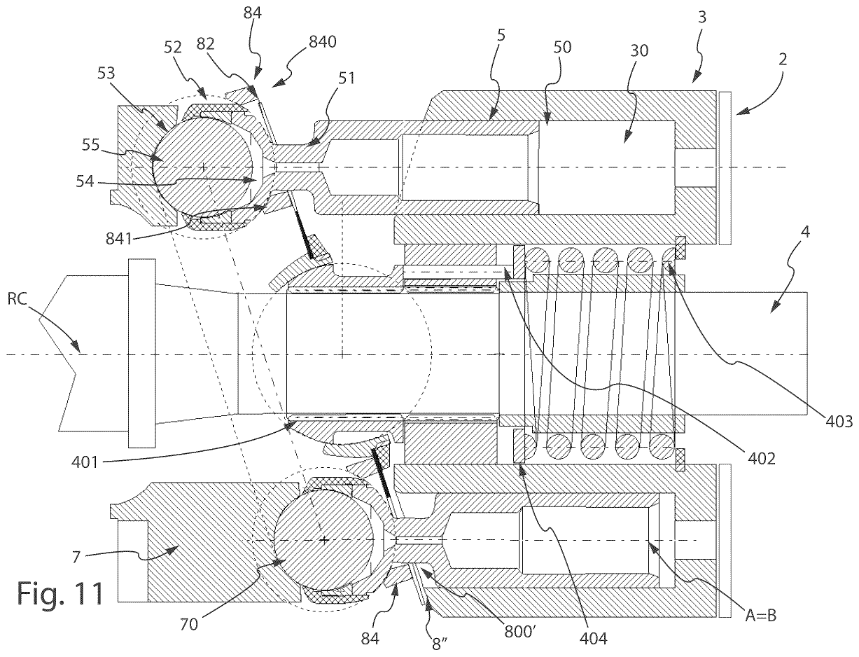

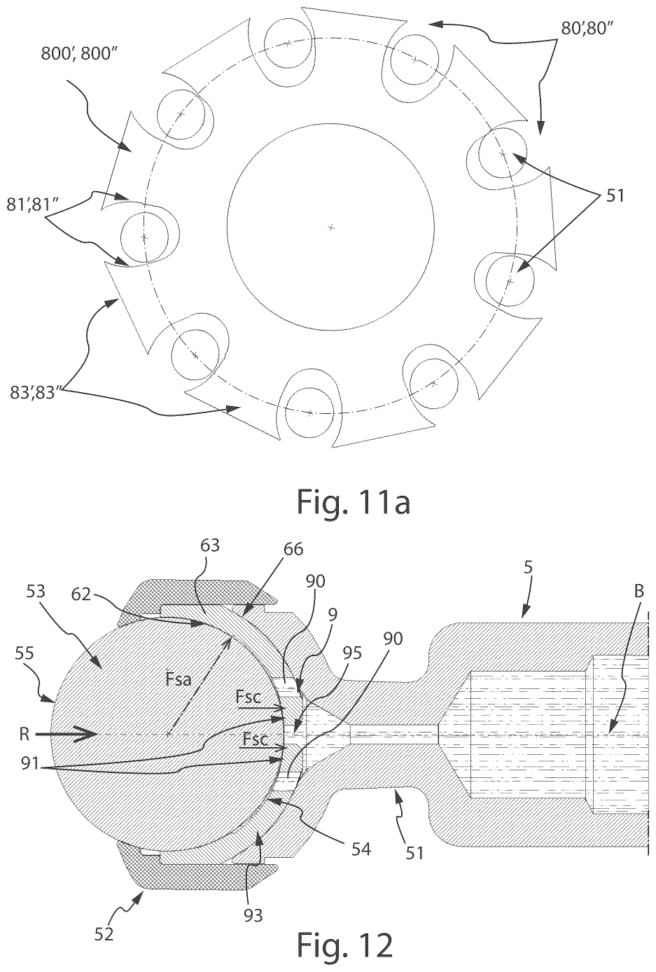

FIGS. 10 and 11 show in longitudinal section a part of two further alternative embodiments of a hydraulic machine of the type of an improved axial piston pump, according to the invention;

FIG. 11a is a front view of a detail of FIGS. 10 and 11;

FIG. 12 shows on an enlarged scale a further embodiment of the second end of a pumping piston of a pump according to the invention;

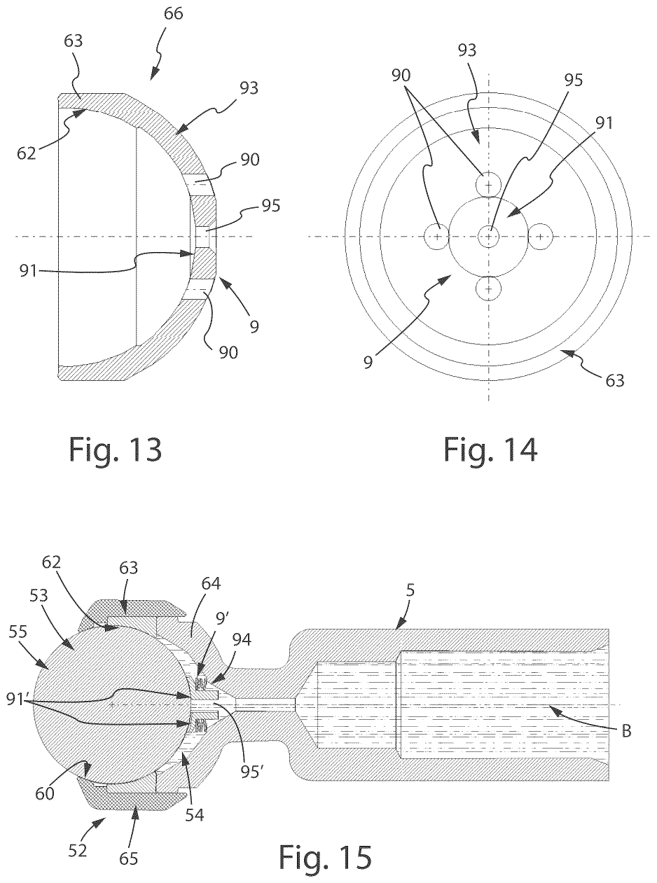

FIGS. 13 and 14 show in longitudinal section and in front view a detail of FIG. 12;

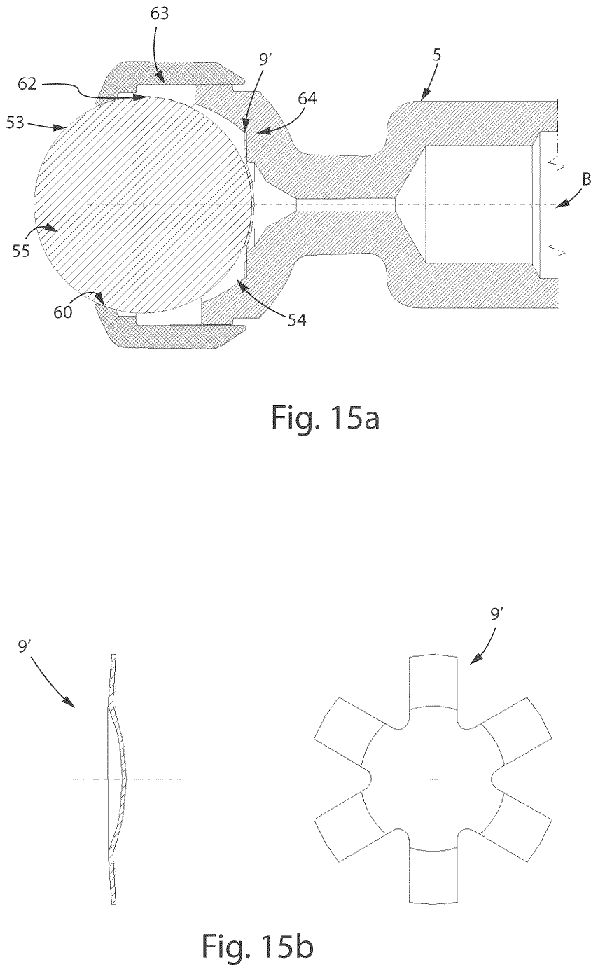

FIG. 15 shows on an enlarged scale a further embodiment of the second end of a pumping piston of a pump according to the invention;

FIGS. 15a and 15b show on an enlarged scale a further embodiment of the second end of a pumping piston of a pump according to the invention;

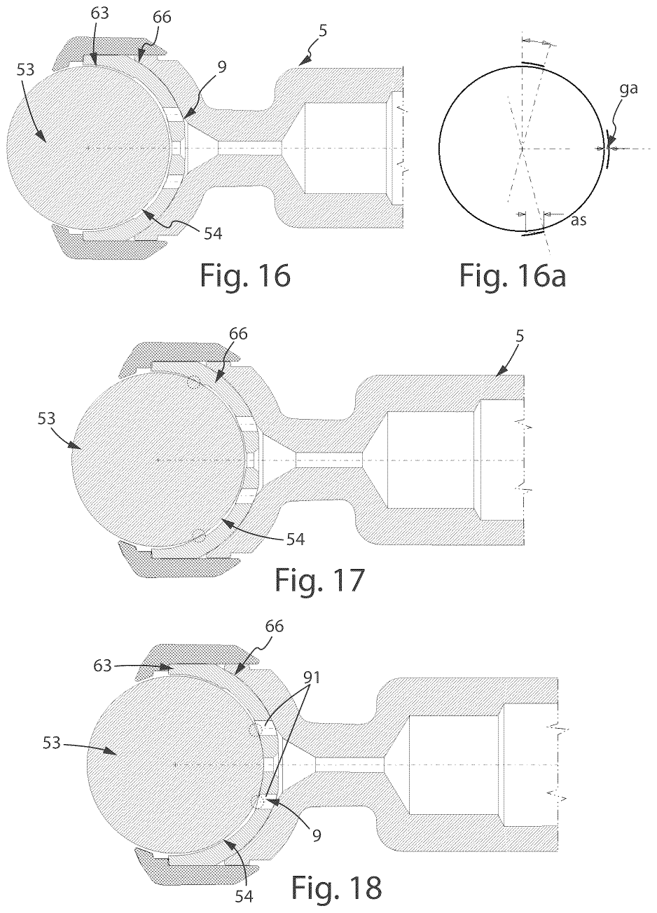

FIGS. 16, 17 and 18 are views like that of FIG. 12 and which show, in a schematic and exaggerated way in terms of clearances between the various components, the second end of the pumping piston respectively in an ideal situation, in which the sphere is floating and not in contact with the inner side surface of the respective seat, a situation of abnormal contact between the sphere and the inner side surface of the respective seat and a situation of correct contact between the sphere and the inner side surface of the respective seat;

FIG. 16a schematically shows some sizing parameters.

With reference to the cited figures, there is shown an improved axial piston hydraulic machine according to the present invention and which can consist of a hydraulic pump or of a hydraulic motor. In the following, reference will be made to the case of a hydraulic pump indicated globally with the reference numeral 1, which comprises a cylinder block with a body 3 having a central longitudinal axis RC and housing a plurality of pistons 5, also referred to as pumping pistons 5, in respective axial seats 30 formed in the body 3 itself.

The pumping pistons 5 or, rather, their respective axial seats 30 can be distributed along a circumference; that is, they are distributed in such a way that their longitudinal axes A are parallel to each other and distributed along a cylindrical surface with a circular cross-section. The axial seats 30 therefore have their own longitudinal axis A preferably parallel to the central axis RC of the body 3.

There is however the alternative possibility of arranging the axial seats 30 with their axes A inclined relative to the central axis RC and, therefore, lying on a conical surface coaxial to the central axis RC and of which they constitute respective generatrixes. This inclination has some advantages, including making the geometry of the pump more tolerant of manufacturing errors at the expense of greater construction complication.

Each of the pumping pistons 5 is axially movable within the respective axial seat 30. The axial seats 30 define the “liners” of the cylinders within which the pumping pistons 5 slide.

Each pumping piston 5 has a longitudinal axis B generally substantially coaxial with the axis A of the respective axial seat 30.

Each of the pumping pistons 5 comprises a first end 50 internal to the axial seat 30 and a second end 52 axially opposite to the first end 50.

The pump 1 further comprises a plate 7 inclined relative to the central axis RC of the body 3, facing the second ends 52 of the pumping pistons 5 and in contact with said second ends 52 of the pumping pistons 5. The pump 1 is therefore of the inclined plate type (swash-plate).

The relative rotation of the body 3 with respect to the inclined plate 7, or vice versa, generates an axial movement of each of the pumping pistons 5 within the respective axial seat 30. This axial movement of the pumping pistons 5 is adapted to pump a fluid (i.e. a liquid) contained in the respective axial seat 30. At the end of the body 3 opposite to that facing the inclined plate 7 there is a distributor 2, which is only schematically represented, since it is of a known type, in which the suction and delivery ports are obtained.

In the embodiments shown in the accompanying figures, the body 3 is dragged into rotation with respect to the inclined plate 7. The body 3 is coaxial to the drive shaft 4. The body 3 and the drive shaft 4 are made integral in rotation by a splined coupling and/or by interference.

As is known, the pump 1 further comprises a box or case, not depicted, for containing its components.

According to the invention, each of the pumping pistons 5 comprises, at the second end 52, a contact sphere 53 and a seat 54 in which the contact sphere 53 is at least partially housed. The contact sphere 53 is free to rotate within the seat 54. The contact sphere 53 is housed within the seat 54 so as to comprise a portion 55 external to the seat 54 itself. The seat 54 for the contact sphere 53 therefore has an opening 540 through which the outer portion 55 of the contact sphere 53 protrudes. This opening 540 is coaxial to the axis B of the respective pumping piston 5. The outer portion 55 of the sphere is intended to contact the plate 7.

The seat 54 for the contact sphere 53 is in fluid communication with the axial seat 30 housing the respective pumping piston 5 such that, generally, the fluid pumped by the pumping piston 5 fills at least the volume internal to the seat 54 that is comprised between the outer surface of the contact sphere 53 and the inner side surface of the seat 54 itself.

Advantageously, in this way, the contact of the second end 52 of the pumping piston 5 with the inclined plate 7 is a mainly rolling contact instead of a sliding contact. Furthermore, the rotation of the contact sphere 53 within the seat 54 is lubricated by the presence of the pumped fluid, which is at the delivery pressure when the pumping axial force is present and urges contact, and which, from the axial seat 30. penetrates into the inner volume of the seat 54. The opening 540 is defined at the end of the seat 54 axially opposite that in fluid communication with the axial seat 30. As will become clearer below, moreover, the support of the contact sphere 53 in the seat 54 is mainly hydrostatic, since under usual operating conditions, what can be defined as two opposing hydrostatic bearings or double hydrostatic bearing that maintains the contact sphere 53 in substantial balance in a position detached from the inner side surface of the seat 54 are/is formed.

As will become clearer below, the stability of such a balance is guaranteed by the choice of the diameters that the inner side surface of the seat 54 has at cross sections (i.e. sections on planes orthogonal to the axis B of the respective pumping piston 5) which are chosen so that the possible contact between the contact sphere 53 and the inner side surface of the seat 54 takes place at them, or rather around them, so that, in the event that such contact takes place, the balance of the forces acting on the contact sphere 53 brings it back to hydrostatic support conditions.

Preferably, the seat 54 is a substantially spherical seat as it is configured to house, with a—at least locally-shape coupling, the contact sphere 53. Preferably, as will become clearer below, the seat 54, however, is not perfectly spherical with a single curvature radius.

Preferably, the body 3 housing the pumping pistons 5 is rotatable around its own central axis RC, which therefore defines the rotation axis of the rotatable body 3. Alternatively, the inclined plate 7 is rotatable about its own rotation axis with respect to the body 3.

Preferably, the inclined plate 7 comprises a guide track 70 substantially complementary to the outer portion 55 of the contact spheres 53 in the section perpendicular to the path of the centre of said contact sphere 53. The guide track 70 may consist of a recess, or cradle, with transverse profile in the shape of an arc of circumference. Preferably, the surface of the guide track 70 is shaped so as to have with respect to the surface of the outer portion 55 of the contact sphere 53 a degree of conformity c comprised between 0.5 and 0.55 included (0.5<c<0.55), where the degree of conformity c is defined by the ratio between the curvature radius Rp of the guide track 70 in a section orthogonal to the path of the contact sphere 53 and twice the curvature radius Rs of the contact sphere 53:

$$c = Rp / ( 2 * Rs ) .$$

The guide track 70 develops along a line that can be imagined as the guide line for the centre of the contact spheres 53. The projection of the development line of the guide track 70 on the inclined plane IP defined by the inclined plate 7 can have a substantially circular or elliptical shape unless there are any geometric deviations.

If, at the design stage, it is wished for the path of the contact spheres 53, when projected on a plane OP orthogonal to the central axis RC of the body 3, to be circular, then the projection of the development line of the guide track 70 on the inclined plane IP will be elliptical, as immediately understandable from geometric relationships known to the person skilled in the art.

This choice is preferred in the event that the pump 1 is a fixed displacement pump, with a barrel of the pumping piston 5 that is cylindrical, meaning by “barrel” the portion of the pumping pistons 5 sliding in the respective axial seats 30.

If, at the design stage, it is wished for the path of the contact spheres 53, when projected on a plane OP orthogonal to the central axis RC of the body 3, to be elliptical, then the projection of the development line of the guide track 70 on the inclined plane IP will be circular, as immediately understandable from geometric relationships known to the person skilled in the art.

This choice is preferred in case the pump 1 is a variable displacement pump, i.e. with inclined plate 7 of variable inclination. In this case, the barrel of the pumping pistons 5 is shaped to be conical, preferably bi-conical, as described later.

In this regard, an advantage resulting from the contact between the contact sphere 53 and the guide track 70 with respect to the contact between the skids and the guide track of the known pumps is noted from now on. Specifically, the inclination of the guide track 70, defined by the derivative before the axial coordinate with respect to the angular coordinate of the development line of the guide track is no longer mandatory, as is the case for flat skids that must couple with a plane. This permits more sophisticated laws of motion with a compensation of the delivery irregularities.

In the event that the pumping pistons 5 have the conical barrel, it is however not mandatory that the shape of the path followed by the contact spheres 53 is circular on the inclined plane IP and elliptical on the plane OP orthogonal to the central axis RC: small deviations that are appropriate to improve some characteristics of the motion can be adopted without problems.

Preferably, the contact sphere 53 is housed within the respective seat 54 so as to be movable with a small axial movement clearance along the axis B of the pumping piston 5 itself. Said clearance is preferably in the order of 1-5 times the radial clearance between the contact sphere 53 and its housing. Advantageously, in this way, the contact sphere 53 can, in addition to rotating inside the seat 54, also float along the axial direction defined by the axis B, supported hydrostatically.

The seat 54 consists of a cavity formed at the second end 52 of the pumping piston 5 and in which the respective contact sphere 53 is at least partially housed.

With specific reference to the embodiments represented in the accompanying FIGS. 1-11 and 15, the seat 54 is defined by the assembly of a plurality of components that follow one another and that are coupled to each other:
A hollow terminal portion 64 of the body of the pumping piston 5;
A holding ring 65 or “envelope” which is coupled and fixed to the terminal portion 64 of the body of the pumping piston 5;
A ring 63 interposed between the end of the terminal portion 64 of the body of the pumping piston 5 and the holding ring 65.

The seat 54 is defined by the cavity delimited by the inner side walls of the terminal portion 64, of the ring 63 and of the holding ring 65 assembled together.

The holding ring 65 comprises or in any case defines the opening 540 from which the outer portion 55 of the containment sphere 53 protrudes. The holding ring 65 is coupled and fixed to the terminal portion 64 which, for this purpose, has a centring area and an outer projection or groove in which the holding ring 65 is traced.

Preferably, the ring 63 is arranged within a corresponding portion of the holding ring 65 and is constrained to the terminal portion 64 by means of the holding ring 65 itself. The hollow terminal portion 64 is in fluid communication with the chamber 500 internal to the pumping piston 5 by means of a calibrated hole 501, where the chamber 500 is in fluid communication with the volume internal to the axial seat 30.

The embodiment shown in FIGS. 12-14 and 16-18 differs from those in FIGS. 1-11 and 15 in that the ring 63 is an integral part of a cup 66 otherwise housed in the terminal portion 64 of the body of the pumping piston 5. In this case, therefore, as it becomes evident, the seat 54 is defined by the cavity delimited by the inner side walls of the cup 66 (including the ring 63) and of the holding ring 65 assembled together and fixed to the terminal portion 64 of the pumping piston 5.

However, alternative construction forms with which to realize the seat 54 are not excluded.

However constructively realized, preferably the seat 54 comprises a first annular portion 60 proximal to the opening 540 and which defines a contact area with the contact sphere 53 having, in section on a plane orthogonal to the axis B, an inner diameter D60 smaller than the diameter D53 of the contact sphere 53, where D53 is equal to 2×Rs, Rs being the curvature radius of the sphere. This first annular portion 60 is adapted to hold the contact sphere 53 within the seat 54.

The seat 54 further comprises a second annular portion 62 distal from the opening 540 and which defines a contact area with the contact sphere 53 having, in section on a plane orthogonal to the axis B, an inner diameter D62 smaller than the diameter D53 of the contact sphere 53.

The contact sphere 53 is axially movable, along the longitudinal axis B of the pumping piston 5, between an external extreme position, wherein it is abutting against the contact area defined by the first annular portion 60, and an inner extreme position, wherein it is abutting against the contact area defined by the second annular portion 62. The outer and inner extreme positions of the contact sphere 53 are defined with reference to the seat 54.

It is specified from now on that, for the reasons illustrated below, under usual operating conditions of the pump 1, the contact sphere 53 is hydraulically supported in equilibrium in a position in which it is detached from the inner side surface of the seat 54, without there being any contact between it and the contact area of inner diameter D62 and D60 or other portions of the inner side wall of the seat 54. If, then, such contact occurs, it must take place only on one side, following the side force that is generated during pumping. As will be explained below, an annular type contact, following an unwanted imbalance of the axial forces acting on the contact sphere 53 with consequent axial translation thereof, is in fact to be avoided.

The first annular portion 60 is more distant from the first end 50 of the pumping piston 5 than is the second annular portion 62, the latter being arranged upstream of the first with respect to the inclined plate 7.

The contact area of inner diameter D60 defined by the first annular portion 60 and the contact area of inner diameter D62 defined by the second annular portion 62 lie at the opposite sides of a plane orthogonal to the longitudinal axis B and passing through the centre of the contact sphere 53.

Advantageously, therefore, as mentioned above, the contact sphere 53 can float axially, as well as rotate, within the seat 54 between an outer extreme position, schematically illustrated in FIG. 3, and an inner extreme position, schematically illustrated in FIG. 4.

In the following, for simplicity's sake, reference will be made to a reference system integral with the pumping piston 5, considering which, therefore, the contact sphere 53 is movable with respect to the pumping piston 5. As evident to the person skilled in the art, considering the pump 1 under operating conditions, the contact sphere 53 is pushed and held in contact with the inclined plate 7, so that following the equal and opposite reaction force it is the pumping piston 5 that is movable with respect to the contact sphere 53.

That said, as illustrated in FIG. 3, if the force F_hy generated by the hydrostatic pressure of the fluid present in the volume internal to the seat 54 is greater than the reaction force R impressed by the inclined plate 7 on the contact sphere 53, the contact sphere 53 will tend to move into the outer extreme position of contact with the contact area defined by the first annular portion 60. If, on the other hand, the force F_hy is lower than the reaction force R, the contact sphere 53 will tend to move into the inner extreme position of contact with the contact area defined by the second annular portion 62.

In essence, therefore, the contact sphere 53 floats within the seat 54 as a function of the resultant of the axial forces acting on the sphere 53 itself. The reaction force R between the contact sphere 53 and the inclined plate 7 is generally equal to the pressure of the pumped fluid for the area of the cross-section of the pumping piston 5 (except for frictional forces that are negligible here).

Preferably, the second annular portion 62 of the seat 54 consists of the inner surface of the ring 63. The inner surface of the ring 63 that contributes to forming the seat 54 has a curvature radius substantially coincident, except for deviations described later, with the curvature radius of the contact sphere 53, such that in the inner extreme position of the contact sphere 53, said contact sphere 53 adheres to the inner surface of the ring 63 at the contact area defined by the second annular portion 62. Preferably, the first annular portion 60 of the seat 54 is defined by a portion of the inner surface of the holding ring 65 in proximity of the opening 540.

As illustrated in the accompanying figures (see in particular FIGS. 2a, 3 and 4), the volume internal to the seat 54 comprised between the seat 54 itself and the outer surface of the contact sphere 53 is subdivided into two annular chambers:
A first chamber 56a extending between the contact area (of diameter D62) defined by the second annular portion 62 and the calibrated hole 501;
A second chamber 56b extending between the contact area (of diameter D62) defined by the second annular portion 62 and the contact area (of diameter D60) defined by the first annular portion 60.

The first chamber 56a is in fluid communication with the cavity 500 of the pumping piston 5 and, therefore, with the axial seat 30. The first chamber 56a is in fluid communication with the second chamber 56b through a first meatus g1 comprised between the mutually facing surfaces of the second annular portion 62 and the contact sphere 53.

The second chamber 56b is in fluid communication with the volume external to the pumping piston 5 (i.e. volume internal to the box of the pump 1) through a second meatus g2 comprised between the mutually facing surfaces of the first annular portion 60 and the contact sphere 53.

The first and second meatus g1 and g2 are of the order of magnitude that a person expert in the field well knows for the “journal bearings”, therefore, generally comprised between 1/300 and 1/1500 of the diameter D53 of the contact sphere 53.

As mentioned above, the contact area of inner diameter D60 defined by the first annular portion 60 and the contact area of inner diameter D62 defined by the second annular portion 62 lie at the opposite sides of a plane orthogonal to the longitudinal axis B and passing through the centre of the contact sphere 53; therefore, the first chamber 56a and the second chamber 56b likewise lie at the opposite sides of a plane orthogonal to the longitudinal axis B and passing through the centre of the contact sphere 53.

The second chamber 56b is constructively formed at a portion of the holding ring 65 having an inner diameter greater than that of the first annular portion 60.

Two opposing hydrostatic bearings are thus realized that place the contact sphere 53 in a very stable balance condition:
A first hydrostatic bearing identified by the first chamber 56a, which forms the relative sump thereof, and by the first meatus g1;
A second hydrostatic bearing identified by the second chamber 56b, which forms the relative sump thereof, and by the second meatus g2.

As mentioned above, according to one aspect of the present invention the contact sphere 53 is supported by this pair of hydrostatic bearings which, under usual operating conditions, keep it in substantially stable balance between the outer extreme position (FIG. 3) and the inner extreme position (FIG. 4), in the absence of contacts and in particular of edge contacts.

As is known, a hydrostatic bearing is a bearing in which the support with detachment between the two coupled surfaces is guaranteed by the feed of pressurized oil.

In the case of coupling between skids and inclined plate of the known pumps, the balance condition in the support of the skids P is established as the distance (“gap” G, FIG. 1) between their flat lower surface and the corresponding upper surface of the inclined plate PI increases, with consequent decrease in the pressure of the fluid in the central sump PC (FIG. 1) thereof due to the pressure drop through the calibrated hole, which pressure drop increases with the speed of the fluid.

We focus on what happens in the prior art (FIG. 1). Let P2 be the delivery pressure of the fluid, P1 the pressure of the fluid in the box of the pump and, therefore, externally to the skid P, and P21 the pressure of the fluid in the central sump PC, where P1 varies between atmospheric pressure (in open circuit pumps) and a few bars (in closed circuit pumps), while P2 varies between tens and hundreds of bars.

The central sump PC of the skid P is in fluid communication with the chamber internal to the pumping piston by means of a calibrated hole FC. As the fluid leaks from the chamber internal to the pumping piston (at pressure P2) to the central sump PC (at pressure P21) through the calibrated hole FC and from the central sump PC to the box of the pump through the meatus formed by the “gap” G, its pressure gradually decreases passing from P2 to P1, where P1<P21<P2.

The hydrostatic bearing that is generated in the meatus formed by the gap “G” generates a support force Fs given by the integral of the difference of pressure local to it on the lower surface area of the skid P, where the pressure local to it decreases from the value P21 at the central sump PC up to P1 outside the skid P.

It should be noted that according to the prior art, the hydrostatic bearing generates a support force Fs directed mainly from the inclined plate PI toward the top or ceiling of the piston, but inclined by the angle of the inclined plate, since it is perpendicular to the inclined surface of the plate.

The dimension Fp in the direction of the axis of the piston of the support force Fs must balance the force F acting on the piston (which force F is the pumping force given by the area that belongs to the diameter of the piston multiplied by the delivery pressure P2−P1):
If F>Fp, the height of the meatus formed by the “gap” G decreases, consequently the flow rate of the leaking fluid decreases and, hence, the pressure drop in the calibrated hole FC decreases, so that in the central sump PC the pressure P21 increases and the support force Fs grows;
If F<Fp, the height of the meatus formed by the “gap” G grows, consequently the flow rate of the leaking fluid grows and, hence, the pressure drop in the calibrated hole FC increases, so that in the central sump PC the pressure P21 drops and the support force Fs decreases.

As the pressure P2 (and therefore the force F acting on the piston), the temperature (and therefore the viscosity of the fluid) and, to a lesser extent, other magnitudes, vary, the height of the meatus formed by the “gap” G varies.

In the case of coupling between the skids and the inclined plate of the known pumps, however, the balance condition in the hydrostatic support of the skids P that is thus created is not particularly stable, since the skid P can tilt on the spherical joint SN. Such an inclination entails two effects:
The minimum distance between the lower surface of the skid P and the upper surface of the inclined plate decreases locally, so the risk of edge contact between the skid and the inclined plate is greater.
The outflow of fluid through the meatus increases. The outflow is in fact proportional to the cube of the height of the meatus (height of the “gap” G); therefore, even if the average value of the meatus remains constant, a localised increase in its maximum value entails an increase in the outflow. Such an increase in the outflow entails an increase in the pressure drop due to leakage through the calibrated hole FC and therefore a reduction in the pressure P21 in the central sump PC with a consequent further increase in the risk of edge contact between the skid and the inclined plate.

In addition, as indicated in the introduction, increases in the “gap” G are disadvantageous in terms of volumetric efficiency of the pump.

According to the prior art, therefore, there is only one hydrostatic bearing formed on the outside of the piston-skid assembly and which generates a support force Fs directed from the inclined plate toward the ceiling of the piston.

According to the present invention, instead, as mentioned above, two opposing hydrostatic bearings or a “double-acting” or “double” hydrostatic bearing are created:
When the contact sphere 53 displaces itself into the inner extreme position with respect to the body of the pumping piston 5 (on the right in FIGS. 3 and 4), in the volume internal to the second chamber 56b the pressure of the fluid decreases, not being in communication with the volume internal to the first chamber 56a, and the contact sphere 53 is pushed to return to a central balance position.
When instead the contact sphere 53 displaces itself into the outer extreme position with respect to the body of the pumping piston 5 (on the left in FIGS. 3 and 4), in the volume internal to the second chamber 56b the pressure increases, it being in communication with the volume internal to the first chamber 56a, and the contact sphere 53 is pushed to return to a central balance position.

To obtain such a hydrostatic support of the contact sphere 53, the diameters of the seat 54 at the contact areas defining the inner and outer extreme positions, i.e. the inner diameters D60 and D62 already defined above, and the diameter D53 of the contact sphere 53 must meet the following conditions (see in particular FIG. 2a):
Let “D” be the outer diameter of the pumping piston 5 measured at its portion sliding in the respective axial seat 30, then:
(a) The inner diameter D60 at the contact area defined by the first annular portion 60 and the contact sphere 53 must be smaller than the outer diameter D of the pumping piston 5: D60<D.
(b) The diameter D62 at the contact area defined by the second annular portion 62 and the contact sphere 53 must be greater than the outer diameter D of the pumping piston 5: D62>D.
(c) The diameter D53 of the contact sphere 53 must be greater than the outer diameter of the pumping piston 5: D53>D.

Where, in addition, as indicated above, the diameter D53 of the contact sphere 53 is greater than both the inner diameter D60 and the inner diameter D62, it then results that:

$$( d ) D 60 < D < D 62 < D 53.$$

Advantageously, the difference (D−D60) varies between (−0.5)% and (−4)%.

Advantageously, the difference (D62−D) varies between +0.5% and +4%

Advantageously, the difference (D53−D) varies between +2.5% and +12%

By way of example only, in a possible embodiment it is:

D60=16.7 mm; D=17 mm; D62=17.3 mm; D53=18.0 mm

Differences of this order of magnitude may not be perceivable from all the accompanying figures; they are in any case represented in an enlarged way in FIG. 2a.

If all of the above indicated conditions are met, then:
If, for any transient reason, the contact sphere 53 “displaces itself” into the inner extreme position of contact with the seat 54 at the contact area of inner diameter D62 (FIG. 4), then, being D62>D the force F_hy generated by the hydrostatic pressure of the fluid present in the first chamber 56a prevails over the reaction force R impressed by the inclined plate 7 on the contact sphere 53 (R<F_hy) returning the contact sphere 53 toward the central balance position.
If, for any transient reason, the contact sphere 53 “displaces itself” into the outer extreme position of contact with the seat 54 at the contact area of inner diameter D60 (FIG. 3), then, being D60<D, R prevails over F_hy (R>F_hy) returning the contact sphere 53 toward the central balance position. Where the contact reaction R is substantially equal to the area of the cross-section occupied by the pumping piston 5 for to the pressure of the pumped fluid present in the axial seat 30.

It should be specified that, as already mentioned above, in the present description reference is made to a displacement of the contact sphere 53 in the seat 54 with respect to the pumping piston 5, having taken as reference a reference system integral with the pumping piston 5 itself. However, what practically happens is that the pumping piston 5, and with it the seat 54, displace with respect to the contact sphere 53, whose displacement is prevented through obstacle from the necessary contact with the inclined plate 7.

Whatever the reference system adopted, the operation is as follows.

Let P2 be the delivery pressure of the fluid at which the fluid is in the chamber 500 of the pumping piston 5, P1 the pressure of the fluid in the box of the pump and, therefore, externally to the contact sphere 53, P2′ the pressure of the fluid in the first chamber 56a (sump of the first hydrostatic bearing) and P21 the pressure of the fluid in the second chamber 56b (sump of the second hydrostatic bearing), where P1 varies between atmospheric pressure (in open circuit pumps) and a few bars (in closed circuit pumps), while P2 varies between tens and hundreds of bars and P2′ is substantially equal to or slightly lower than P2.

The fluid, as known, leaks from the higher pressure area (P2) toward the lower pressure area (P1) with a sufficient speed to generate the overall pressure drop (P2−P1).

Since the first chamber 56a is defined between a plane orthogonal to the longitudinal axis B and passing through the centre of the contact sphere 53 and the end of the seat 54 axially opposite to the opening 540, the resulting pressure force exerted on the contact sphere 53 is directed from the first end 50 to the second end 52 of the pumping piston 5, i.e. it is directed toward the inclined plate 7.

Since the second chamber 56b is defined between a plane orthogonal to the longitudinal axis B and passing through the centre of the contact sphere 53 and the opening 540, the resulting pressure force exerted on the contact sphere 53 is directed from the second end 52 to the first end 50a of the pumping piston 5, i.e. it is directed toward the ceiling of the pumping piston 5.

Taking into account the relationships between the diameters D62 and D60 indicated above (D60<D<D62), the projection of the area of the sumps defined by the first chamber 56a and by the second chamber 56b on a plane perpendicular to the longitudinal axis B is unbalanced in favour of the first which, therefore, is greater than the second.

Therefore, the resultant of the pressure forces acting on the contact sphere 53 to balance the constraint reaction R is directed from the first end 50 to the second end 52 of the pumping piston 5, i.e. it is directed toward the inclined plate 7.

As a whole, therefore, the double hydrostatic bearing, according to the present invention, generates on the contact sphere 53 a support force F_hy (FIGS. 3 and 4) directed from the ceiling of the pumping piston 5 toward the inclined plate 7, in contrast to what happens in the solution according to the prior art (FIG. 1).

Furthermore, the double hydrostatic bearing according to the present invention is, as a whole, internal to the system pumping piston 5—contact sphere 53 and not instead external to the latter. Along the direction of the longitudinal axis B this system is subject to a force F acting on the first end 50 of the pumping piston 5 opposed to a constraint reaction force R (equal and contrary) acting on the contact sphere 53.

The balance of the forces acting on the contact sphere 53 that hydrostatically support it in a central position is particularly strong, since as the first meatus g1 (first hydrostatic bearing) grows, the second meatus g2 of the second hydrostatic bearing decreases proportionally and vice versa:
When the first meatus g1 decreases, which occurs following a relative displacement of the contact sphere 53 with respect to the seat 54 toward the inner extreme position of the sphere itself (FIG. 4), the leakage of fluid through the first meatus g1 also decreases and at the same time the second meatus g2 increases, thus the pressure drop between the pressure internal to the second chamber 56b (P21) and the pressure internal to the box of the pump 1 (P1) decreases. Since the pressure of the fluid internally to the second chamber 56b (P21) decreases, the pressure force exerted by the second bearing on the contact sphere 53 decreases and which, as seen above, is directed toward the first end 50 of the pumping piston 5, restoring the balance because the support force F_hy generated by the double hydrostatic bearing and acting on the contact sphere 53 increases and prevails over R until the first meatus g1 conveniently increases again.
When the first meatus g1 increases, which occurs following a relative displacement of the contact sphere 53 with respect to the seat 54 toward the outer extreme position of the sphere itself (FIG. 3), the leakage of fluid through the first meatus g1 increases and, consequently, the pressure drop between the pressure internal to the first chamber 56a (P2′) and the pressure internal to the second chamber 56b (P21) decreases. Simultaneously the second meatus g2 decreases and, consequently, the leakage of fluid from the second chamber 56b toward the box of the pump 1 decreases, so that the pressure of the fluid internally to the second chamber 56b (P21) increases. Since the pressure of the fluid internally to the second chamber 56b (P21) increases, the pressure force exerted by the second hydrostatic bearing on the contact sphere 53 increases and which, as seen above, is directed toward the first end 50 of the pumping piston 5, restoring the balance because the support force F_hy generated by the double hydrostatic bearing and acting on the contact sphere 53 decreases and R prevails until the first meatus g1 decreases again and conveniently.

It should be noted that, in the present invention, the amount of fluid leakages is much lower than the amount of the leakages required in the hydrostatic bearings according to the prior art (FIG. 1):
although, in fact, the first meatus g1 and the second meatus g2 are of the same order of magnitude as the meatus that is generated between a skid and the inclined plate of the prior art (“gap” G) and have a length on average equivalent to that of the latter, in the present invention the meatuses are two and are arranged in series, which implies approximately a halving the fluid losses;
in the search for the balance condition, there is no significant increase in the losses, because when one between the first meatus g1 and the second meatus g2 increases, the other decreases, and vice versa, which makes the leakage of fluid substantially constant as its viscosity or other operating conditions vary.

In other words, consider the contact sphere 53 ideally in its inner extreme position (FIG. 4) and therefore in contact with the contact area of inner diameter D62 defined by the second annular portion 62:
The fluid present within the first chamber 56a is statically at a pressure P2′ close to the delivery pressure P2. It then results that the first chamber 56a is at the maximum delivery pressure P2, while the second chamber 56b is at the minimum pressure. Since the cross-section at the contact area of inner diameter D62 has a diameter greater than the outer diameter D of the pumping piston 5, a condition of instability is generated since there is a lack in the balance of the forces and the support force F_hy acting on the contact sphere 53 prevails over the constraint reaction R moving the contact sphere 53 away from its inner extreme position.
This thus opens the first meatus g1 through which the fluid leaks from the first chamber 56a to the second chamber 56b. A gradual pressure drop is thus generated along the length of the first meatus g1 such that the fluid present in the second chamber 56b is characterized by a pressure P21 substantially constant and lower than that P2′ of the fluid present in the first chamber 56a, but greater than the minimum pressure P1, there being a second pressure drop during the leakage through the second meatus g2. The smaller the first meatus g1 is, the greater the hydraulic support force F_hy acting on the contact sphere 53 is. Therefore, the first meatus g1 will grow until balancing the forces acting on the contact sphere 53, as the greater the first meatus g1 is, the smaller the pressure difference between the first chamber 56a and the second chamber 56b is. The stability is then ensured by the fact that, as the first meatus g1 increases, the support force F_hy decreases not only because the pressure drop between the first chamber 56a and the second chamber 56b decreases, but also because the second meatus g2 is closed, thus making the pressure of fluid internal to the second chamber 56b increase.

Consider instead the opposite situation with the contact sphere 53 ideally in its outer extreme position (FIG. 3) and therefore in contact with the contact area of inner diameter D60 defined by the first annular portion 60:
The fluid present in the first chamber 56a and in the second chamber 56b would be at a pressure P2′ close to the delivery pressure. In this situation, having to consider the cross section of inner diameter D60, the support force F_hy is smaller than the constraint reaction R, since the inner diameter D60 is smaller than the outer diameter D of the pumping piston 5. A condition of instability is therefore generated, since the balance of the forces is lacking and the constraint reaction R prevails over the support force F_hy by moving the contact sphere 53 away from its outer extreme position.

From the above it emerges that the first meatus g1 and the second meatus g2 can never remain closed, therefore the contact sphere 53 will be permanently supported in equilibrium between the inner extreme position and the outer extreme position and detached from both contact areas of inner diameter D62 and D60 by hydrostatic effect.

Preferably, in order to guarantee that condition (b) is met—i.e. in order to guarantee that the condition of ideal contact between the contact sphere 53 and the inner side surface of the second annular portion 62 occurs at a contact area of inner diameter D62 greater than the outer diameter D of the pumping piston 5 (D62>D)—in the upstream 620 and downstream 621 areas of said contact area the inner side surface of the first annular portion 62 is lowered, i.e. shaped so as to prevent an undesired contact between the contact sphere 53 and the seat 54 from occurring at them. The detail in FIG. 4a shows how this can occur in the upstream 620 and downstream 621 areas of the contact area with inner diameter D62.

One of the geometric shapes that can lead to this result is in fact a revolution figure obtained by the revolution around the longitudinal axis B of the pumping piston 5 of a flat figure having a curvature radius RV greater than the radius Rs of the contact sphere 53 with centre beyond the longitudinal axis B as depicted in FIG. 4b. In FIG. 4b a portion of a degenerate torus is schematized where the radius of the torus is large enough to cause a negative value of the distance between the centre of the tube and the centre of the torus.

It should be noted that the contact between the contact sphere 53 and the contact area of inner diameter D62 schematized in FIG. 4b must only take place on one side, following the side force generated during pumping. As already mentioned and as will be explained below, an annular type contact, due to an unwanted imbalance of the axial forces with consequent axial translation of the contact sphere 53, is to be avoided, since the possibility of the contact sphere 53 being wedged must be avoided.

A solution similar to that described with reference to FIGS. 4a and 4b is adopted to ensure that condition (a) is met—i.e. to ensure that the ideal contact between the contact sphere 53 and the inner side surface of the first annular portion 60 takes place at a contact area of inner diameter D60 smaller than the outer diameter D of the pumping piston 5 (D60<D) and there is no contact in undesired areas such as the area indicated with 600 in FIG. 3a.

The inclined plate 7 may be a variable inclination plate 7′. In this way, the improved axial piston pump has a variable displacement. Conversely, if the inclined plate 7 has a fixed inclination, the improved axial piston pump has a fixed displacement. In the case of a variable inclination plate 7′, the guide track 70, i.e. the projection thereof on an inclined plane IP parallel to the inclined plate 7, can favourably be developed along a circular line, thus defining on a plane OP orthogonal to the central axis RC an elliptical trajectory for the second ends 52 of the pumping pistons 5. Other similar shapes, but slightly different from this one described, can be adopted for example in order to minimize the conicity of the pistons, necessary in the case of a variable inclination.

The guide track 70 is preferably configured so as to suitably couple with the outer portion 55 of the contact sphere 53 in every inclination that the plate can assume.

Preferably the axial seats 30 are substantially cylindrical seats. The pumping pistons 5 have an outer surface characterized by a first conical thinning 58 toward the first end 50 of the piston 5 itself, and by a second conical thinning 59 toward the second end 52 of the piston 5 itself. In essence, the pumping pistons 5 have an outer surface having a double conicity converging toward the opposite ends of the piston 5.

The first conical thinning 58 and the second conical thinning 59 extend along a respective longitudinal portion of the body of the pumping piston 5. Advantageously, the longitudinal portion along which the first conical thinning 58 extends (the one extending toward the first end 50) has a length lower than that along which the second conical thinning 59 extends (the one extending toward the second end 52, i.e. toward the contact sphere 53). See FIGS. 5 and 6. The order of magnitude of the conicity of the first conical thinning 58 and of the second conical thinning 59 is 0.5°=1.5° for maximum inclination angles of the path of the contact spheres 53 in the order of 16°=18°.

Advantageously, in this way, by varying the inclination of the inclined plate 7′, the pumping pistons 5 can tilt slightly within the respective axial seat 30, thus being able to slide axially within the axial seat 30 without jamming against the walls thereof. This behaviour is schematically illustrated in FIGS. 5 and 6. FIG. 5 illustrates the axial piston pump 1 with inclined plate 7′ in a zero inclination position, while FIG. 6 illustrates the axial piston pump 1 with plate 7′ inclined by 16° with respect to the central axis RC. From the comparison of these two FIGS. 5 and 6 it can be seen how the pumping piston 5 is positioned differently within its own axial seat 30 as a function of the inclination assumed by the inclined plate 7′.

Advantageously, in the case of fixed displacement axial piston pumps, i.e. having an inclined plate 7 with fixed inclination, the guide track 70 can develop along a circular or elliptical line.

Taking as reference the inclined plane IP and an axis centred in the centre of the circumference or of the ellipse (or of any figure otherwise used) and perpendicular to the inclined plane IP, if this line develops along an ellipse, its projection on a plane OP perpendicular to the rotation axis of the cylinder block becomes a circumference and this is advantageous because it eliminates the need for the conicity of the pumping pistons 5.

Advantageously also in the event that the guide track 70 of the inclined plate 7 develops along a circular line, to avoid jamming of the pumping pistons 5 in the respective seat 30, the pumping pistons 5 have an outer surface characterized by a first conical thinning 58 toward the first end 50 of the piston 5 itself and by a second conical thinning 59 toward the second end 52 of the piston 5 itself.

The axial piston pump 1 may further comprise a holding element 8 configured to push the second ends 52 of the pumping pistons 5 against the inclined plate 7, in order to keep the contact spheres 53 in contact with the inclined plate 7 itself.

Preferably the pumping pistons 5 comprise, in an intermediate position between the first end 50 and the second end 52, a thinned portion or neck 51. The holding element 8 comprises a flat annular portion 800 provided with a plurality of openings 80 configured to accommodate the thinned portion 51 of the pumping pistons 5. The edge 81 of said openings 80 is configured to press against an abutting portion 82 of the pumping piston 5 in proximity of the thinned portion 51. This abutting portion 82 is defined by a spherical cap. The abutting portion 82 consists of the outer side surface of the terminal portion 64 of the body of the pumping piston 5.

As mentioned above, the contact sphere 53 is axially movable along the longitudinal axis B between an inner extreme position and an outer extreme position.

Preferably, the spherical cap forming the abutting portion 82 has as its own centre the centre of the contact sphere 53, lying on the longitudinal axis B of the pumping piston 5. In essence, being able to identify a centre of the seat 54 lying on the longitudinal axis B of the pumping piston 5, the spherical cap forming the abutting portion 82 has as its own centre the centre of the seat 54.

For the fixed displacement pumps, as mentioned, it is possible to describe an elliptical path on the inclined plane IP, so that the centre of the contact sphere 53 is always on the longitudinal axis A of the axial seat 30 within which the pumping piston 5 moves. Conversely, for the variable displacement pump, the centre of the contact sphere 53 moves between a minimum radius and a maximum radius, which are referred to the central axis RC of the cylinder block. In this case, when the same is in a central position, or half its stroke, it is preferable that it is equally spaced from both the inner position and the outer position.

Advantageously, as illustrated in FIG. 9, the edge 81 of the openings 80 of the holding element 8 defines a contact point, preferably of the tangential type, with the respective abutting portion 82 of the pumping piston 5 and exerts a force Fr acting in a radial direction with respect to the contact sphere 53, as well as to the seat 54, since said abutting portion 82 defines a spherical cap whose centre is coincident with that of the contact sphere 53. In FIG. 9 the circumference representing the sphere of which the abutting portion 82 with spherical cap is a part is indicated with CB.

In a preferred embodiment, the openings 80 may be slits or radial slots which are open at the outermost radial end. Between two successive openings 80, a fin 83 remains thus defined which can confer flexibility to the flat annular portion 800. The openings 80 have a width greater than the diameter of the thinned portion 51 of the pumping pistons 5 inserted therein.

The holding element 8 may have different configurations. In a possible embodiment, shown in FIGS. 2 to 9, the holding element 8 comprises a tubular neck 801 which extends coaxially to the flat annular portion 800 and which is mounted on the drive shaft 4 inclined by an angle a such that the flat annular portion 800 is parallel to the plane IP. Advantageously, the tubular body 801 and the flat annular portion 800 are made as a single body, preferably made of an anti-friction material, by which is meant a material with good sliding characteristics, such as for example bronze.

One or more springs acting between the body 3 and the drive shaft 4 not depicted in FIGS. 2 to 9 are then provided.

In order to improve the kinematic coupling between the holding element 8 and the abutting portion 82 of each pumping piston 5, a pusher is preferably provided, as shown in the alternative embodiments referred to in FIGS. 10 and 11, but which, as immediately understandable to a person skilled in the art, can be adopted also in the embodiment of FIGS. 2 to 9.

With particular reference to FIGS. 10 and 11, the holding element 8′,8″ has at each opening 80′,80″ a respective pusher 84 consisting of a tubular element having at an end a flat surface 840 resting with the lower surface of the flat portion 800′,800″ of the holding element 8′,8″ and at the opposite end a hollow spherical surface 841 which rests on the surface of the spherical cap forming the abutting portion 82 of the body of the pumping piston 5. The hollow spherical surface 841 of each pusher 84 has a profile complementary to that of the spherical cap that constitutes the abutting portion 82 of the pumping piston 5, so as to couple with it.

The pushers 84 ensure the tangency between the plane along which the flat portion 800′,800″ of the holding element develops and the spherical cap that constitutes the abutting portion 82 in any position assumed by the pumping pistons 5 in their motion, even when the tangency condition would occur at the neck 51 of the pumping pistons 5.

The embodiment shown in FIG. 10 differs from that shown in FIGS. 2 to 9 in that the holding element 8′ does not consist of a single body: the tubular body 801′ and the annular portion 800′ are made as separated pieces coupled together by a holding ring 802.

In particular, the flat annular portion 800′ is made in the form of a flexible sheet which, when viewed in plan, preferably, but not necessarily, has the shape shown in FIG. 11a. The flat annular portion 800′ has openings 80′ which, preferably, may be slits or radial slots open at the outermost radial end and delimited by edges 81′. Between two successive openings 80′, a fin 83′ remains thus defined, which can confer further flexibility to the flat annular portion 800′. The openings 80′ have a width greater than the diameter of the thinned portion 51 of the pumping pistons 5 that has been inserted therein and feature curved or recessed flanks, this is because the flat annular portion 800′ moves on an inclined plane, while the pumping pistons 5 move with their axes on a cylindrical surface.

The flat annular portion 800′ made in the form of a flexible sheet, in particular a flexible metal sheet, has the advantage of itself constituting a spring, allowing to compensate for manufacturing errors and to guarantee a desired pre-load on the contact spheres 53.

The flexible sheet forming the flat annular portion 800′ consists of a sheet with thickness preferably comprised between 1/20 and 1/50 of the diameter D of the pumping pistons 5 if made of steel, or between 1/10 and 1/30 of the diameter D of the pumping pistons 5 if made of bronze or brass.

In the embodiment shown in FIG. 10, the flat annular portion 800′ in the form of a flexible sheet is mounted on the drive shaft 4 by means of the tubular element 801′ to which it is made integral by the holding collar 802. The tubular element 801′ is mounted on the drive shaft 4 with its own axis inclined relative to the central axis R by an angle a. FIG. 10 then shows a spring 400 interposed between the body 3 and the drive shaft 4: this spring 400 has the function of pre-loading the cylinder block against the distributor 2, well known in the current art, except that, instead of discharging the force on the skids, it discharges it on the drive shaft 4, then on the bearings supporting it.

The embodiment shown in FIG. 11 differs from that of FIG. 10 in that in this case the holding element 8″ consists of the only flat annular portion 800″ which is made in the form of a flexible sheet and which is mounted on the drive shaft 4 by means of a spherical joint 401. As to the rest, the flat annular portion 800″ is equal to the flat annular portion 800′ described above with reference to FIGS. 10 and 11a, with openings 80″ with edges 81″ and optionally tabs 83″.

In this case, by means of the spherical joint 401, thrust pins 402 act on the holding element 8″ which are parallel to the central axis RC and housed axially movable in respective seats obtained in the body 3 and on which springs 403 interposed between the body 3 and a plate 404 act, according to a configuration known to the person skilled in the art.

As to the rest, the embodiments shown in FIGS. 10 and 11 correspond to that shown in FIGS. 2 to 9 and corresponding elements are indicated with the same reference numerals.

It is reiterated that the pushers 84 shown in FIGS. 10 and 11 can also be advantageously applied to the embodiment shown in FIGS. 2 to 9.

Optionally and preferably, the pump 1 may comprise a contact body 9,9′ (see FIGS. 12 to 18) housed in or concurrent with forming the seat 54 substantially coaxial to the longitudinal axis B of the pumping piston 5 and in fluid communication with the respective axial seat 30. The contact body 9,9′ forms an annular area with spherical geometry configured to contact the contact sphere 53 at a portion thereof opposite the outer portion 55, i.e. opposite the opening 540.

In general terms, the contact body 9,9′ is formed by a spherical cap-like portion coaxial to the axis B and having at a central discoidal portion a lightening or, rather, a through hole 95 externally to which an annular contact area is defined whose surface defines a contact surface 91,91′ with the contact sphere 53.

The contact surface 91,91′ is substantially spherical with a curvature radius substantially equal to that of the contact sphere 53, i.e. slightly increased in the order of 2-10%. The contact surface 91,91′ is therefore preferably annular, so as to prevent contact with the side surface of the contact sphere 53 from occurring at the longitudinal axis B of the pumping piston 5 and for this reason, the contact body 9, 9′ is just crossed by a central through hole 95. The contact surface 91,91′ is configured and dimensioned to prevent, following an axial displacement of the contact sphere 53, it from wedging and contacting along an annular area of the second annular portion 62. This could happen if the delivery pressure is very low, or even negative (in relative terms), such as for example during the suction step.

FIGS. 16, 17 and 18 show schematically and deliberately exaggerated in terms of the dimensions of the clearances between the various components the contact sphere 53 in different possible positions.

FIG. 16 shows an ideal situation in which the contact sphere 53 is floating and completely detached from the inner side surface of the seat 54 thanks to the hydrostatic support exerted by the double hydrostatic bearing described above.

FIG. 17 shows a situation of undesired contact to be avoided, in which the contact sphere 53, following an axial movement in extreme and unbalance conditions of the axial forces, contacts the second annular portion 62 at an annular contact area highlighted by circling in FIG. 17. This can cause a blocking of the contact sphere 53 with consequent slippage, rather than rolling, thereof on the guide track 70 due to the contact angle that serves as an amplifier of the contact force and to the consequent frictional force.

FIG. 18, on the other hand, shows a favourable contact situation that is generated thanks to the provision of the contact body 9,9′.

The contact sphere 53, following an axial movement under extreme and unbalance conditions of the axial forces, comes into contact with the annular contact surface 91, 91′ of the contact body 9, 9′ and this cannot cause a blocking of the contact sphere 53. As detailed below, in fact, on the one hand the contact body 9,9′ is made of a material (e.g. bronze, “bearing grade” technopolymer, etc.) that has a coefficient of friction in the contact with the contact sphere 53 (made of steel) significantly less than that generated in the contact with the guide track 70 (also made of steel), and, on the other hand, the contact forces that are generated between the contact sphere 53 and the annular contact surface 91,91′ are essentially equal and with a direction parallel to the longitudinal axis B of the pumping piston 5, thus the amplification effect due to the contact angle being cancelled.

The contact surface 91,91′ is in fact configured and dimensioned to contact the outer side surface of the contact sphere 53 before it contacts, by wedging, an annular area of the second annular portion 62, i.e. of the inner side surface of the ring 63.

As schematized in FIG. 16a, indicating with ga the maximum axial clearance between the contact sphere 53 and the contact body 9,9′, with as the axial contact displacement of the contact sphere 53 with the first annular portion 62 and with ac the contact angle at the minimum meatus between the contact sphere 53 and the first annular portion 62, it must be ga<as.

The contact angle ac is defined at the design stage, depending on the working conditions for which it is wished to optimize the pump, together with the ratio between the various diameters in play and the clearances chosen. It may, for example, vary between 10 and 40°.

As immediately understandable to a person skilled in the art, in fact, there are situations in which the pump 1 can operate even with negligible or very low pressure. For example, just think of the conditions that are created during the return and suction stroke of the pumping pistons 5, in which the hydraulic forces are very low and even of the opposite sign (suction depression).

In such cases, the hydrostatic support of the contact sphere 53 ceases and the forces exerted by means of the holding element 8,8′,8″ by the preload springs prevail over the hydraulic forces acting on the contact sphere 53, however they are made. In such conditions, the contact sphere 53 tends to displace into the inner extreme position (FIG. 4) and, in the absence of hydraulic support, it, since it is pressed against the inner surface of the ring 63 tends to block and, consequently, to slip in the contact with the guide track 70.

The contact forces Fsa that are generated between the contact sphere 53 and the inner surface of the ring 63, in fact, would have a significantly greater value than the contact reaction R between the contact sphere 53 and the guide track 70, so that the friction forces in the contact sphere 53 and the inner surface of the ring 63 would cause the sphere 53 to slip in the contact with the guide track 70, despite a coefficient of friction in the contact sphere 53 and the inner surface of the ring 63 (steel-bronze) lower than that in the contact between the contact sphere 53 and the guide track 70 (steel-steel).

For example (see FIG. 12), in case of a clearance of 25-30 μm between contact sphere 53 and the inner side surface of the ring 63, a contact sphere 53 of diameter equal to 18 mm could be wedged with a contact angle ac of 20°-30°. In this case the contact force Fsa would be equal to R/sin αc, where R is the contact reaction between contact sphere 53 and guide track 70. So Fsa would also be equal to twice or three times R, which would lead to the blockage of the contact sphere 53 with consequent slippage, rather than rolling, thereof on the guide track 70. The contact body 9,9′ is aimed at preventing situations as described above from being generated. That is, its aim is to prevent the pre-load forces exerted by means of the holding element 8,8′,8″ from wedging the contact sphere 53 on the inner surface of the ring 63 blocking its rotation when the hydrostatic support ceases.

As mentioned above, the contact body 9,9′ is configured and dimensioned such that in the event of an axial translation of the contact sphere 53 relatively to the seat 54 in the direction of approach to the first end 50, the outer side surface of the contact sphere 53 contacts as first the contact surface 91,91′ defined by it with the generation of a contact force Fsc substantially parallel to the longitudinal axis B of the pumping piston 5 and, therefore, substantially equal to the contact reaction R between the contact sphere 53 and the guide track 70. In this way, the friction coefficient difference between the contact of the contact sphere 53 with the guide track 70 (steel-steel) and the contact of the contact sphere 53 with the contact body 9,9′ (steel-bronze, significantly lower than the first) will lead to having a friction force between the contact sphere 53 and the guide track 70 greater than the friction force between the contact sphere 53 and the contact surface 91,91′ of the contact body 9,9′, which guarantees the rotation of the contact sphere without slippage.

In the embodiment shown in FIGS. 12-14, the contact body 9 is made as one piece with the ring 63 to form a cup 66 of which the contact body 9 constitutes the bottom and the ring 63 an edge portion.

Between the contact body 9 and the ring 63 there is an annular joining wall 93 whose inner side surface is lowered with respect to the inner side surface of the ring 63 and of the contact body 9, so that no contact with the contact sphere 53 will take place at it and a sump at constant pressure equal to the pressure of the pumped fluid is created. To this end, the joining wall 93 is crossed by one or more through holes 90 that place the sump delimited by it in fluid communication with the calibrated hole 501 of the pumping piston 5 and, therefore, with the axial seat 30.

In the cup 66, it is therefore possible to identify three areas:
A first annular area at the ring 63 and at which the second annular portion 62 is defined which forms the first meatus g1 with the contact sphere 53.
A second annular area at the joining wall 93. At this second annular area, the meatus between the seat 54 and the contact sphere 53 is large enough not to cause significant pressure variations due to the leakage of the fluid. This second annular area is in fluid communication via one or more holes 90 with the calibrated hole 501 of the pumping piston 5. By way of example, the increase in the meatus, at this second annular area, by a factor of four compared to that of the first annular area is sufficient to make the aforementioned pressure drops negligible. To obtain this result, at the annular joining wall 93 (externally to the annular contact surface 91) the inner side surface that delimits the seat 54 has an increasing curvature radius or in any case lowerings or removals of material 92 which are adapted to avoid contact between the contact sphere 53 externally to the contact surface 91 and to ensure that there is a sufficiently large meatus, in the aforementioned terms.
A third annular area at the contact body 9. The contact body 9 defines an annular contact area with the contact sphere 53 intended to contact the latter in the substantial absence of hydrostatic support with the generation of a contact force Fsc substantially parallel to the axis B of the pumping piston 5.

In a possible alternative embodiment (FIG. 15), the contact body 9′ is made as a body separated from the ring 63 and forming a skid that is pushed toward the contact sphere 53 by means of at least one spring 94 interposed between it and the pumping piston 5.

In a further possible alternative embodiment (FIGS. 15a and 15b), the contact body 9′ is made as a body separated from the ring 63 and forming a flexible skid integrating the function of spring adapted to push it toward the contact sphere 53. FIG. 15b shows this contact body 9′ in front view and in side elevation, there are cracks adapted to also let the fluid pass toward the hydrostatic bearings.

In any case, the contact body 9,9′ or at least the contact surface 91,91′ thereof is made of bronze or of a material having with respect to the contact sphere 53 a coefficient of friction lower than that which the contact sphere 53 has with the guide track 70.

The contact spheres 53 and the inclined plate 7, or at least the guide track 70, can be made of hardened steel, preferably steel specific for rolling bearings (e.g. 100CR6).

The second annular portion 62, i.e. the ring 63 that forms it can be made of bronze, brass or other suitable anti-friction material such as some high-performance “bearing grade” technopolymers.

The first annular portion 60, having to provide for the possibility of accidental contact with the contact sphere 53, must also be made of an anti-friction material that also has good mechanical characteristics like bronze or brass.

The description reported above refers to an axial piston pump, but is more generally referable to a hydraulic machine that can also be operated as a motor.

The operation of the improved axial piston pump is clear and evident from what has been described.

In particular, during operation of the pump, the contact spheres 53 roll along the inclined plate 7, and more precisely roll in the guide track 70. The movement of the contact spheres 53 is assimilable to the movement of the spheres of a ball bearing inside the slewing ring.

Furthermore, by effect of the movement of the axial pistons 5 within the axial seats 30, the liquid is sent, under pressure, into the seat 54 so as to fill, in particular, the volume present between the seat 54 and the contact sphere 53. This pressurized liquid supports the contact sphere 53 in a floating manner inside the seat 54 through hydrostatic support effects, and simultaneously contributes to the lubrication thereof, improving the contact efficiency between the contact sphere 53 and the inclined plate 7.

In practice, it has been found that the improved axial pump, that is, the hydraulic machine, according to the present invention, fulfils the task as well as the purposes set as it allows to prevent malfunctions and unwanted wears notoriously due to the sliding of the skids of the pumping pistons on the inclined plate.

Another advantage of the present invention consists in that the contact between the end of the pumping pistons and the inclined plate occurs mainly by rolling instead of by sliding.

A further advantage of the present invention consists in that the contact between the end of the pumping pistons and the inclined plate is of a point type, widening into an ellipse under load as a hertzian contact. The absence of edges prevents the generation of unwanted edge contact forces. In addition, the rolling point contact of Hertzian type makes the relative movement between the end 52 of the pumping piston 5 and the inclined plate 7 much less sensitive to the presence of contamination particles inside the liquid being pumped, also because the hardness of the components is much higher (hardened steel approximately 740 HV, instead of the bronze or brass skids indicatively between 100 and 200 HB).

Another advantage of the present invention consists in that the contact sphere is always lubricated by the pumped liquid, and in that the liquid loss is very low.

Another advantage of the present invention consists in that the guide track of the contact spheres on the inclined plane can be shaped in such a way that, in the section between suction and delivery (and vice versa) the stroke of the pistons is zero, so as to eliminate the energy losses related to this volume variation which, in the traditional solution, occurs with a nominally closed volume, thus forcing the fluid to leak through small meatuses with significant energy losses and high pressure variations in a short time that result in vibrations and noise.

The improved axial piston hydraulic machine, in particular a hydraulic pump or a hydraulic motor, thus conceived is susceptible to numerous modifications and variants all falling within the scope of the inventive concept.

Furthermore, all the details can be replaced by other technically equivalent elements.

In practice, any materials can be used according to requirements, as long as they are compatible with the specific use, the dimensions and the contingent shapes.

The invention claimed is:

1. An improved axial piston (1) hydraulic machine (1) comprising:
a cylinder block with a body (3) having a central axis (RC) and housing a plurality of pistons (5) in respective axial seats (30), each of said pistons (5) being axially movable within a respective axial seat (30), said pistons (5) comprising a longitudinal axis (B), a first end (50) internal to the respective axial seat (30) and a second end (52) axially opposite to said first end (50); and
a plate (7) inclined relative to said central axis (RC), said plate facing said second ends (52) of said pistons (5) and being in contact with said second ends (52) of said pistons (5), a relative rotation between said body (3) and said inclined plate (7) generating an axial movement of each piston (5) within the respective axial seat (30), said axial movement being related to a fluid contained in the respective axial seat (30),
wherein each piston (5) comprises, at said second end (52), a contact sphere (53) and a seat (54) for said contact sphere (53), said contact sphere (53) being partially housed in said seat (54) and being free to rotate in said seat (54), said contact sphere (53) comprising an outer portion (55) external to said seat (54) and protruding from an opening (540) of said seat (54) for contacting said inclined plate (7), said seat (54) for said contact sphere (53) being in fluid communication with said axial seat (30) such that said fluid at least partially fills a volume of said seat (54) comprised between an outer surface of said contact sphere (53) and an inner side surface of said seat (54).

2. The improved axial piston hydraulic machine (1), according to claim 1, wherein said body (3) is rotatable around said central axis (RC), said central axis (RC) defining a rotation axis of said rotatable body (3).

3. The improved axial piston hydraulic machine (1), according to claim 1, wherein said inclined plate (7) comprises a guide track (70) complementary to said outer portion (55) of said contact sphere (53) in a section perpendicular to a path of a center of said contact sphere (53).

4. The improved axial piston hydraulic machine (1), according to claim 1, wherein said contact sphere (53) is movable with an axial movement clearance inside said seat (54) for said contact sphere (53) along the longitudinal axis (B) of a respective piston (5).

5. The improved axial piston hydraulic machine (1), according to claim 1, wherein said seat (54) for said contact sphere (53) comprises:
a first annular portion (60) proximal to said opening (540) and defining a first contact area having an inner diameter (D60) smaller than a diameter (D53) of said contact sphere (53) and designed to hold said contact sphere (53) within said seat (54), and
a second annular portion (62) distal from said opening (540) and defining a second contact area having an inner diameter (D62) smaller than the diameter (D53) of said contact sphere (53),
said contact sphere (53) being axially movable between an outer end position, wherein said contact sphere is abutting against said first contact area, and an inner end position, wherein said contact sphere is abutting against said second contact area.

6. The improved axial piston hydraulic machine (1), according to claim 5, wherein said first contact area and said second contact area lie at opposite sides of a plane orthogonal to said longitudinal axis (B) and passing through a center of the contact sphere (53).

7. The improved axial piston hydraulic machine (1), according to claim 6, wherein said second annular portion (62) is defined by an inner side surface of a ring (63) coupled to said piston (5), said inner side surface of said ring

(63) having a curvature radius coincident with a curvature radius of said contact sphere (53) at said second contact area.

8. The improved axial piston hydraulic machine (1), according to claim 5, wherein said first annular portion (60) is formed in a holding ring (65) coupled to said piston (5).

9. The improved axial piston hydraulic machine (1), according to claim 5, wherein:
said inner diameter (D60) of said first contact area defined by said first annular portion (60) is smaller than an outer diameter (D) of said piston (5),
said inner diameter (D62) of said second contact area defined by said second annular portion (62) is greater than said outer diameter (D) of said piston (5), and
said diameter (D53) of said contact sphere (53) is greater than said outer diameter (D) of said piston (5).

10. The improved axial piston hydraulic machine (1), according to claim 5, wherein said second annular portion (62) has, externally to said second contact area, a lowered surface (620,621) with respect to a surface of said contact area.

11. The improved axial piston hydraulic machine (1), according to claim 1, further comprising a contact body (9,9′) substantially coaxial to said longitudinal axis (B) of said piston (5) and having an annular contact surface (91,91′) configured to contact said contact sphere (53) at a portion thereof opposite to said outer portion (55) of said contact sphere (53), wherein a force (Fsc) generated by a contact between said contact sphere (53) and said annular contact surface (91,91′) of said contact body (9,9′) extends along a direction parallel or coincident with the longitudinal axis (B) of said piston (5).

12. The improved axial piston hydraulic machine (1), according to claim 11, wherein said contact body (9′) comprises a skid pre-loaded by a spring (94) and adapted to transfer to said contact sphere (53) a force in a direction of the longitudinal axis (B) of said piston (5) for pushing the contact sphere (53) toward said inclined plate (7), and wherein said spring (94) consists of an element separated from said skid or an integral part of said skid.

13. The improved axial piston hydraulic machine (1), according to claim 1, wherein said inclined plate (7) is a variable inclination plate (7′), said axial seats (30) being cylindrical seats, said pistons (5) having an outer surface characterized by a first conical thinning (58) toward said first end (50) and by a second conical thinning (59) toward said second end (52).

14. The improved axial piston hydraulic machine (1), according to claim 1, further comprising a holding element (8) configured to push said second ends (52) of said pistons (5) against said inclined plate (7), said pistons (5) comprising a thinned portion (51) between said first end (50) and said second end (52), said holding element (8) comprising a plurality of openings (80) configured to accommodate said thinned portion (51) of said pistons (5), edges (81) of said openings (80) of said holding element (8) being configured to press against an abutting portion (82) of said piston (5) adjacently to said thinned portion (51), said abutting portion (82) being defined by a spherical cap.

15. The improved axial piston hydraulic machine (1), according to claim 14, wherein, between said holding element (8, 8′, 8″) and said abutting portion (82) of each of said pistons (5), there is a respective pusher (84) which has at an end a hollow surface (841) having a profile complementary to a profile of said spherical cap and in contact therewith.

16. The improved axial piston hydraulic machine (1), according to claim 1, wherein said hydraulic machine is a hydraulic pump, said pistons being pumping pistons (5).

17. The improved axial piston hydraulic machine (1), according claim 1, wherein said hydraulic machine is a hydraulic motor.
